(19) United States
(12) Patent Application Publication
(10) Pub. No.: US 2013/0228053 A1
(43) Pub. Date: Sep. 5, 2013

(54) TORQUE WRENCH WITH FUNCTIONAL LOCK

(71) Applicant: Zhu-Cun CHEN, Taichung City (TW)

(72) Inventor: Zhu-Cun CHEN, Taichung City (TW)

(21) Appl. No.: 13/764,377

(22) Filed: Feb. 11, 2013

(30) Foreign Application Priority Data
Mar. 5, 2012 (TW) 101203941

(51) Int. Cl. B25B 23/142

(52) U.S. Cl. CPC B25B 23/1427
USPC 81/467

(57) ABSTRACT

A torque wrench includes a hollow main shaft, a tool member, an adjustable grip, a torque-adjustment elastic member, a clutch device and a functional lock including a locking ring defining therein a bevel groove, a through hole located at the adjustable grip and a positioning ball received in the bevel groove and insertable through the through hole into contact with the periphery of the hollow main shaft. Thus, the user can control the positioning ball to lock the adjustable grip to the hollow main shaft simply by pushing the locking ring.

### BACKGROUND OF THE INVENTION

1. Field of the Invention

The present invention relates to wrench technology and more particularly to a torque wrench with functional lock, which allows quick switching of a torque limit value adjustment grip between an adjustable unlocking position and a non-adjustable locking position.

2. Description of the Related Art

A conventional wrench is known comprising a hollow main shaft, a tool member mounted at one end of the hollow main shaft for driving a screw nut or screw bolt, and an adjustable grip rotatably mounted at an opposite end of the hollow main shaft, and a clutch device and a spring member mounted inside the hollow main shaft and set between the tool member and the adjustable grip. The adjustable grip can be rotated to push the spring member, thereby changing the prestress of the spring member. The clutch device can be disengaged when the tool member receives a torque larger than the elastic prestress of the spring member, thereby limiting the torque acted on the tool member. Further, during clutch action of the clutch device, an escape percussion sound will be produced to notice the user of the problem that the applied force has been over the limit, avoiding screw nut or screw bolt damage. However, when operating the torque wrench, functional lock means is necessary to lock the adjustable grip, avoiding change of the set torque limit value or hand injuries in a slipping accident.

### SUMMARY OF THE INVENTION

The present invention has been accomplished under the circumstances in view. It is the main object of the present invention to provide a torque wrench with functional lock, which allows quick switching of a torque limit value adjustment grip between an adjustable unlocking position and a non-adjustable locking position.

To achieve this and other objects of the present invention, a torque wrench comprises a hollow main shaft comprising a first and a second end, a tool member inserted into the first end of the hollow main shaft, an adjustable grip comprising an adjustment screw threaded into the second end of the hollow main shaft to secure the adjustable grip to the hollow main shaft and to allow relative rotation between the hollow main shaft and the adjustable grip, a torque-adjustment elastic member mounted inside the hollow main shaft and stopped against one end of the adjustment screw, a clutch device set between the torque-adjustment elastic member and the tool member and pushable by the torque-adjustment elastic member between an engaged position and a disengaged position, and a functional lock comprising a locking ring mounted in between the second end of the hollow main shaft and the adjustable grip and defining therein an axially extending bevel groove, at least one through hole located at the adjustable grip and at least one positioning ball accommodated in the bevel groove inside the locking ring and respectively insertable through the at least one through hole into direct contact with the periphery of the second end of the hollow main shaft.

The main characteristic of the present invention is the arrangement of the functional lock, which enables the user to control engagement between the positioning ball and the hollow main shaft simply by moving the locking ring. Because the positioning ball is inserted through the through hole on the adjustable grip, it can lock the hollow main shaft and the adjustable grip to prevent change of the set torque limit value or hand injuries in a slipping accident during operation.

Preferably, the functional lock further comprises an axial positioning device adapted to positively position the locking ring in the position where the hollow main shaft and the adjustable grip are rotatable relative to each other so that the user can adjust the torque limit value without pulling or pressing the locking ring.

Preferably, the hollow main shaft comprises a plurality of locating grooves spaced around the periphery of the second end thereof and extending along the length thereof for receiving the positioning ball to enhance the locking effect of the functional lock.

Other advantages and features of the present invention will be fully understood by reference to the following specification in conjunction with the accompanying drawings, in which like reference signs denote like components of structure.

### BRIEF DESCRIPTION OF. THE DRAWINGS

FIG. 1 is an elevational view of a torque wrench in accordance with the present invention.

FIG. 2 is an exploded view of the torque wrench in accordance with the present invention.

FIG. 3 is a partial longitudinal sectional view of the torque wrench in accordance with the present invention (I).

FIG. 4 is a partial longitudinal sectional view of the torque wrench in accordance with the present invention (II).

FIG. 5 is a schematic sectional applied view of the present invention, illustrating the adjustable grip and the hollow main shaft locked.

FIG. 6 corresponds to FIG. 5, illustrating the adjustable grip and the hollow main shaft unlocked and rotatable relative to each other.

### DETAILED DESCRIPTION OF THE INVENTION

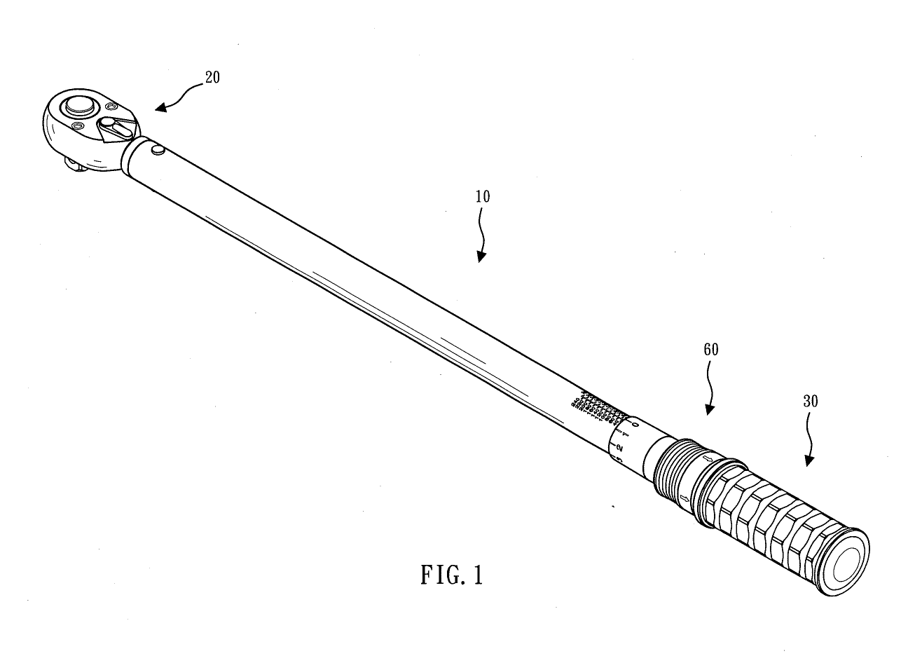

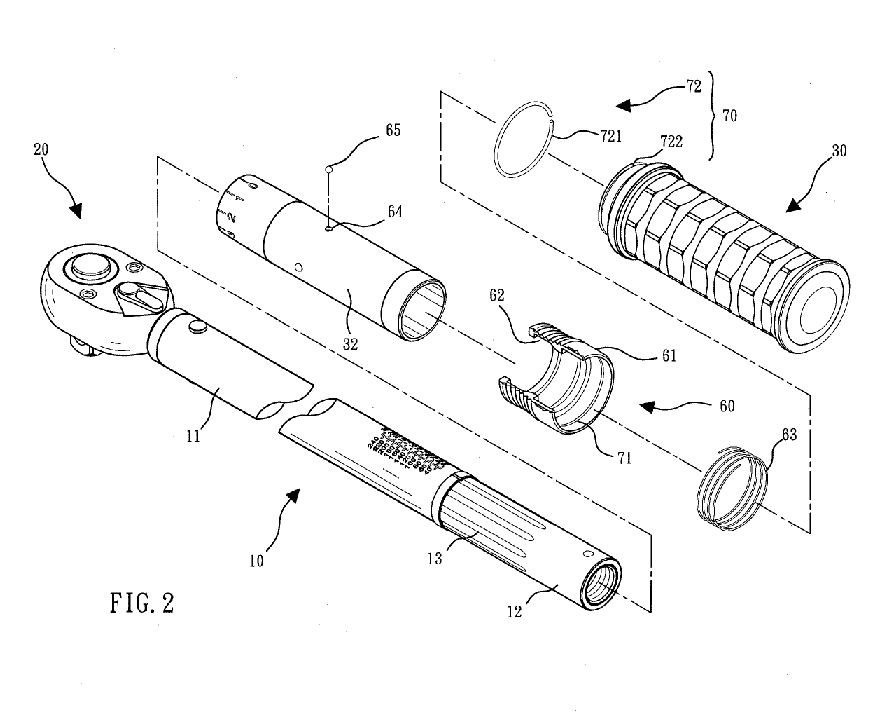

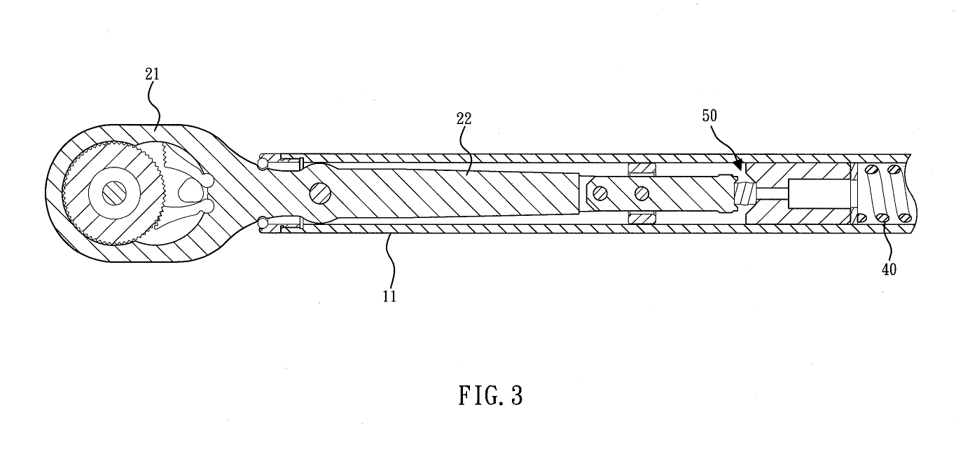

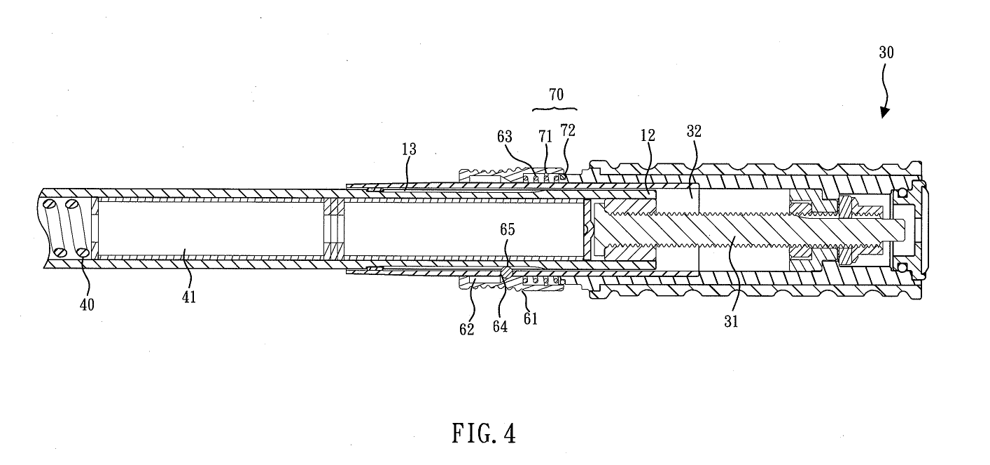

Referring to FIGS. 1-4, a torque wrench in accordance with the present invention is shown. The torque wrench comprises:

a hollow main shaft 10 comprising a first end 11, a second end 12 opposite to the first end 11, and a plurality of locating grooves 13 spaced around the periphery of the second end 12 and extending along the length of the hollow main shaft 10;

a tool member 20 comprising a head piece 21 made in the form of, for example; a ratchet socket joint, and a stem 22 extended from the head piece 21 and inserted into the inside of the first end 11 of the hollow main shaft 10 to support the head piece 21 outside the hollow main shaft 10;

an adjustable grip 30 comprising an adjustment screw 31 fixedly mounted therein on the center and axially coupled to the second end 12 of the hollow main shaft 10 for allowing the adjustable grip 30 to be rotated relative to the hollow main shaft 10;

a torque-adjustment elastic member 40 mounted inside the hollow main shaft 10 and stopped against one end of the adjustment screw 31 either directly or by means of a stopper member 41;

a clutch device 50 set between the torque-adjustment elastic member 40 and the tool member 20 and pushable by the torque-adjustment elastic member 40 between an engaged position and a disengaged position, preferably, the clutch device 50 including a plurality of block members movable by the torque-adjustment elastic member 40 to abut against one another; and

a functional lock 60.

The functional lock 60 comprises:

a locking ring 61 mounted in the junction between the second end 12 of the hollow main shaft 10 and the adjustable grip 30 and defining therein an axially extending bevel groove 62;

a compression spring 63 set between the locking ring 61 and the adjustable grip 30 and adapted to push the locking ring 61 in direction toward the tool member 20 so as to provide an elastic restoring force to the locking ring 61;

at least one through hole 64 located at an extension tube 32, which extends out of the adjustable grip 30 and is sleeved onto the second end 12 of the hollow main shaft 10 over the locating grooves 13; and

at least one positioning ball 65 accommodated in the bevel groove 62 inside the locking ring 61 and respectively insertable through the at least one through hole 64 into direct contact with the periphery of the second end 12 of the hollow main shaft 10.

The aforesaid functional lock 60 further comprises an axial positioning device 70 adapted to keep the locking ring 61 in a position where the hollow main shaft 10 and the adjustable grip 30 are rotatable relative to each other.

Preferably, the axial positioning device 70 comprises:

an annular groove 71 located at and extending around the inner perimeter of the locking ring 61; and

locating means 72 mounted at the adjustable grip 30.

Preferably, the locating means 72 comprises an outside annular groove 722 extending around the periphery of the adjustable grip 30, and an elastic retaining ring 721 mounted at the outside annular groove 722 and engageable into the annular groove 71 to lock the locking ring 61 in the position where the hollow main shaft 10 and the adjustable grip 30 are rotatable relative to each other.

In an alternate form of the present invention, the locating means 72 comprises a ball hole (not shown) located at the adjustable grip 30, a spring-supported ball (not shown) mounted in the ball hole and engageable into the annular groove 71 to lock the locking ring 61 in the position where the hollow main shaft 10 and the adjustable grip 30 are rotatable relative to each other.

The operation of the torque wrench will be outlined hereinafter.

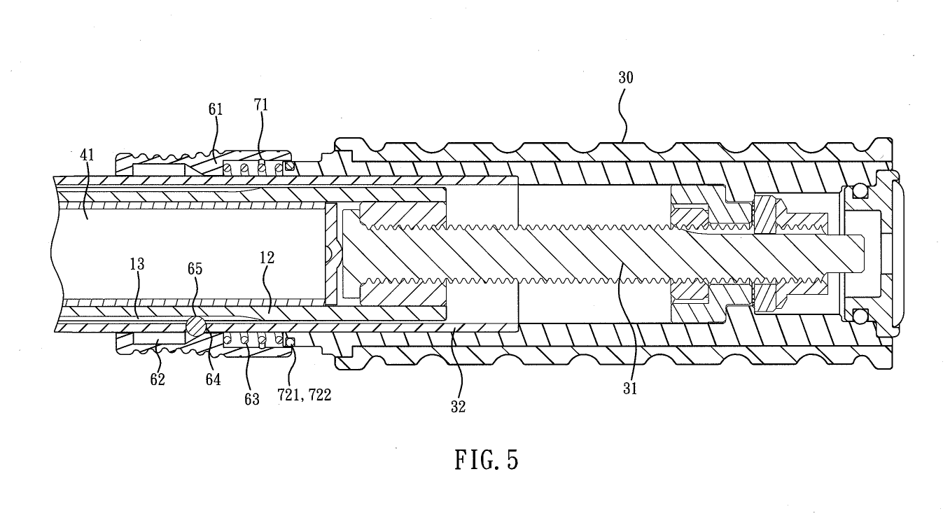

As shown in FIG. 5, the compression spring 63 normally pushes the locking ring 61 toward the tool member 20. At this time, one end (the shadow end) of the bevel groove 62 is kept in contact with the positioning ball 65 to force the positioning ball 65 into engagement with the locating groove 13. Because the positioning ball 65 passes through the through hole 64 at the adjustable grip 30, the hollow main shaft 10 and the adjustable grip 30 are locked and prohibited from rotation relative to each other.

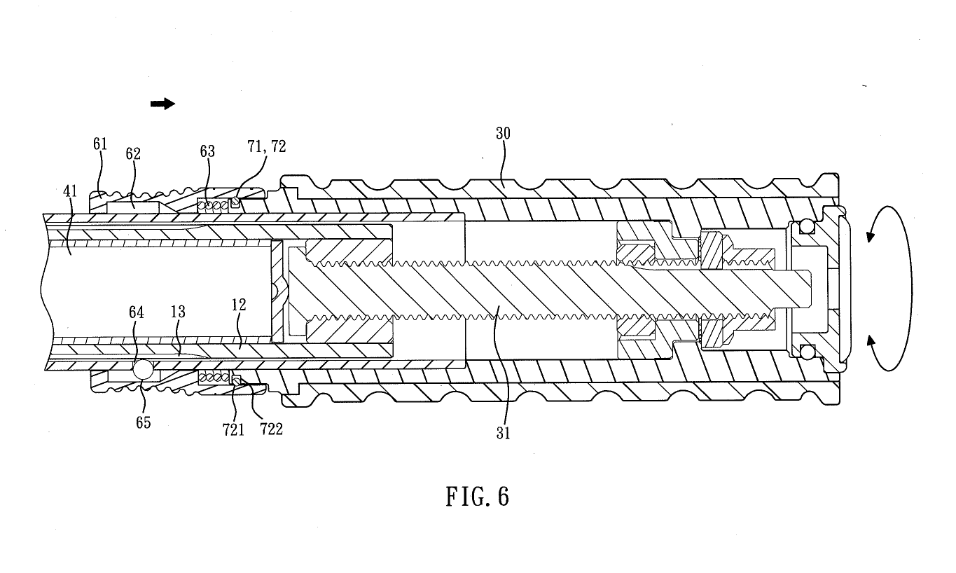

Further, as shown in FIG. 6, when the user wishes to adjust the torque limit value, the user can directly move the locking ring 61 to let the positioning ball 65 be received in the other end (the deep end) of the bevel groove 62. At this time, the positioning ball 65 is disengaged from the locating groove 13, and the elastic retaining ring 721 is allowed to expand and to engage into the annular groove 71, locking the locking ring 61 in the position where the hollow main shaft 10 and the adjustable grip 30 are rotatable relative to each other. Thus, the user can rotate the adjustable grip 30 relative to the hollow main shaft 10 to adjust the pressure imparted by the adjustment screw 31 to the torque-adjustment elastic member 40. Thus, the user can adjust the torque limit value conveniently without pulling or pressing the locking ring 61. After adjustment, the user simply needs to push the locking ring 61 slightly, enabling the locking ring 61 to be returned to its former position by the spring force of the compression spring 63.

Further, matching between the positioning ball 65 and the axial length of the bevel groove 62 limits the maximum range of axial movement of the locking ring 61, preventing the compression spring 63 and the axial positioning device 70 from being exposed to the outside of the adjustable grip 30 or falling down during displacement of the locking ring 61.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A torque wrench, comprising:
a hollow main shaft comprising a first and a second end;
a tool member inserted into said first end of said hollow main shaft;
an adjustable grip comprising an adjustment screw threaded into said second end of said hollow main shaft to secure said adjustable grip to said hollow main shaft and to allow relative rotation between said hollow main shaft and said adjustable grip;
a torque-adjustment elastic member mounted inside said hollow main shaft and stopped against one end of said adjustment screw;
a clutch device set between said torque-adjustment elastic member and said tool member and pushable by said torque-adjustment elastic member between an engaged position and a disengaged position; and
a functional lock comprising a locking ring mounted in between said second end of said hollow main shaft and said adjustable grip and defining therein an axially extending bevel groove, at least one through hole located at said adjustable grip and at least one positioning ball accommodated in said bevel groove inside said locking ring and respectively insertable through said at least one through hole into direct contact with the periphery of said second end of said hollow main shaft.

2. The torque wrench as claimed in claim 1, wherein said functional lock further comprises an axial positioning device adapted to lock said locking ring in a position where said hollow main shaft and said adjustable grip are rotatable relative to each other.

3. The torque wrench as claimed in claim 2, wherein said axial positioning device comprises an annular groove located inside said locking ring, and locating means mounted at said adjustable grip partially protruding over said adjustable grip for engagement into said annular groove to lock said locking ring in the position where said hollow main shaft and said adjustable grip are rotatable relative to each other.

4. The torque wrench as claimed in claim 2, wherein said locating means comprises an outside annular groove extending around the periphery of said adjustable grip, and an elastic retaining ring mounted at said outside annular groove and engageable into said annular groove of said axial positioning device to lock said locking ring in the position where said hollow main shaft and said adjustable grip are rotatable relative to each other.

5. The torque wrench as claimed in claim 2, wherein said locating means comprises a ball hole located at said adjustable grip, and a spring-supported ball mounted at said ball hole and engageable into said annular groove of said axial positioning device to lock said locking ring in the position where said hollow main shaft and said adjustable grip are rotatable relative to each other.

6. The torque wrench as claimed in claim 1, wherein said hollow main shaft further comprises a plurality of locating grooves spaced around the periphery of said second end and extending along the length of said hollow main shaft.

7. The torque wrench as claimed in claim 6, wherein said adjustable grip further comprises an extension tube sleeved onto said second end of said hollow main shaft over said locating grooves.

8. The torque wrench as claimed in claim 1, further comprising a compression spring set between said locking ring and said adjustable grip and adapted to provide an elastic restoring force to said locking ring.

9. The torque wrench as claimed in claim 1, wherein said tool member comprises a head piece, and a stem extended from said head piece and inserted into said first end of said hollow main shaft.

10. The torque wrench as claimed in claim 1, further comprising at least one stopper member set between said torque-adjustment elastic member and said adjustment screw.
